(19) United States
(12) Patent Application Publication
(10) Pub. No.: US 2024/0208606 A1
(43) Pub. Date: Jun. 27, 2024

(54) Freewheel of a Vehicle

(71) Applicant: Robert Bosch GmbH, Stuttgart (DE)

(72) Inventors: Christoph Zimmermann, Nehren (DE); Sigmund Braun, Kusterdingen (DE)

(21) Appl. No.: 18/542,707

(22) Filed: Dec. 17, 2023

(30) Foreign Application Priority Data
Dec. 22, 2022 (DE) 10 2022 214 307.8

(51) Int. Cl. B62M 6/55; F16D 41/30

(52) U.S. Cl. CPC B62M 6/55; F16D 41/30

(57) ABSTRACT

A freewheel of a vehicle, in particular a two-wheeler, includes (i) a crankshaft, (ii) an output shaft having a first gear cog, (iii) a freewheel element having a second gear cog, and (iv) a friction element. The first gear cog and the second gear cog are configured to, when engaged with each other, effect a torque transfer between the output shaft and the freewheel element. The freewheel element is arranged to be displaceable in an axial direction on the crankshaft. The freewheel element is arranged to be non-rotatable relative to the crankshaft in the circumferential direction. The freewheel element and the friction element are connected to one another by means of a helical mechanism, which is configured to effect a translational displacement of the freewheel element and the friction element relative to one another when the freewheel element and friction element rotate relative to one another.

This application claims priority under 35 U.S.C. § 119 to patent application no. DE 10 2022 214 307.8, filed on Dec. 22, 2022 in Germany, the disclosure of which is incorporated herein by reference in its entirety.

### BACKGROUND

The present disclosure relates to a freewheel of a vehicle and a vehicle.

In vehicles, e.g. electric bikes, freewheels are known to date, which are configured to interrupt a connection between a driven output shaft and a motor gear unit, which is connected to the drive motor, if the driven output shaft runs faster than an output of the motor gear unit with respect to the forward direction of rotation, i.e. in the direction of rotation that causes the vehicle to be driven in the forward direction of travel. The actuation of the freewheel is in this case often performed via a gear cog. Known is, e.g., a spring-loaded engagement of such a gear cog, in which case the removal of the torque transfer in the freewheel direction is, e.g., implemented by the teeth of a sawtooth cog sliding against one another.

### SUMMARY

In contrast, the freewheel according to the disclosure with the features set forth herein is characterized by a particularly advantageous design, which functions in a particularly low-wear and low-noise manner in addition to a high robustness. According to the present disclosure, this is achieved by a freewheel of a vehicle, preferably of a two-wheeler, more preferably of an electric bike, comprising a crankshaft, an output shaft, a freewheel element, and a friction element. In particular, the crankshaft and the output shaft are arranged parallel to each other, more preferably coaxial to each other. The output shaft in this case comprises a first gear cog, in particular a front gear cog, and the freewheel element comprises a second gear cog, in particular a front gear cog. The first gear cog and the second gear cog in this case are, when engaged with each other, configured to effect a torque transfer between the output shaft and the freewheel element. In the context of the present disclosure, other geometrical shapes of positive-locking elements can in this case be used instead of teeth or sprockets, which effect a torque transfer between the output shaft and the freewheel element when engaged. In the context of the present disclosure, the term “gear cog” is then understood to mean interlocking elements which, when engaged, effect a torque transfer between the output shaft and the freewheel element. The freewheel element is displaceably arranged on the crankshaft in the axial direction. In addition, the freewheel element is circumferentially arranged non-rotatably on the crankshaft relative to the crankshaft. The freewheel element and the friction element are coupled to each other by means of a helical mechanism. The helical mechanism is in this case configured to effect a translational displacement of the freewheel element and the friction element relative to each another when the freewheel element and friction element rotate relative to each other.

In other words, a freewheel function is provided by implementing a helical mechanism that can be actuated by means of friction closure to engage and disengage the gear cog. In other words, the specific design of the freewheel implements a relative rotation of the crankshaft and the output shaft into a relative rotation of the friction element and the freewheel element via the force closure on the friction element. The helical mechanism in this case causes the freewheel element to be displaced in the axial direction on the crankshaft and thus, in particular, to be displaced away from or towards the first gear cog of the output shaft in order to either disengage or engage the gear cog engagement.

The helical mechanism can in this case be designed in a variety of ways. For example, interlocking helix-shaped elements can be provided on the freewheel element and/or the friction element. Furthermore, any other desired interlocking elements can be arranged on the friction element and the freewheel element, e.g., similar to a slotted guide designed to translate the relative rotation into a relative translational displacement along the axis.

The freewheel thereby offers the advantage that a particularly reliable and robust function of the freewheel can be achieved with a particularly simple and cost-efficient design, which also has advantageous properties in terms of wear and noise generation. In detail, all elements involved in the function can, e.g., be mechanically designed to be particularly robust and designed such that reliable malfunctions can be reliably prevented due to the direct mechanical coupling in all directions of movement or actuation of the freewheel. In addition, since the engagement or disengagement of the gear cog is implemented in a particularly targeted and in especially forced manner by the helical mechanism, for example, undesired slipping of the gear cog can, e.g., be prevented over a longer period of time, which on the one hand prevents noise and on the other hand ensures low wear. In addition, the tooth engagement can in this case be performed in a particularly robust and reliable gripping manner.

Preferred embodiments of the disclosure are also set forth herein.

Preferably, the helical mechanism comprises a thread. In other words, a thread is formed between the freewheel element and the friction element, which effects the corresponding function of translational displacement during relative rotation to each other. The desired kinematics of the coupling between the freewheel element and the friction element can thus be implemented in a particularly simple and cost-efficient manner, and particularly reliably. The thread can in this case be designed in a variety of ways, e.g., in particular as a standard metric thread, or as any desired thread featuring any desired pitch, or the like.

In one embodiment, a predetermined force closure is formed between the output shaft and the friction element in the circumferential direction of the output shaft. This enables a compact and simple freewheel design.

Particularly preferably, the force closure between the output shaft and the friction element comprises a frictional force in the circumferential direction, in particular with respect to the output shaft. In other words, the frictional force is oriented in a tangential direction with respect to the output shaft. In particular, the friction element can in this case be at least partially designed as a hollow shaft, through which the output shaft at least partially protrudes. For example, the friction force can be caused by a radial adhesive force between the friction element and the output shaft. The actuation of the helical mechanism can thereby be easily and purposefully adjusted via the frictional force.

Preferably, the frictional force is generated by means of at least one screw and/or by means of a friction ring. For example, the at least one screw can be screwed into the friction element and push in the radial direction against the output shaft with a predetermined screwing force. The screwing force and therefore the frictional force can thus be generated and adjusted in a particularly simple manner. Multiple screws distributed around the circumference of the output shaft are particularly advantageous. For example, a friction ring can be arranged as an additional element between the friction element and the output shaft. In this case, the friction force can, e.g., be designed as a function of surface roughness and/or fits between the friction element and the friction ring and/or between the output shaft and the friction ring, which also enables a simple and cost-efficient design.

Further preferably, the force closure between the output shaft and the friction element comprises a magnetic force. In other words, the magnetic force is provided between the friction element and the output shaft such that it effects the predetermined friction closure in the circumferential direction. For example, permanent magnets can in this case be arranged on the friction element and/or the output shaft. The force closure can thus also be designed in a simple and particularly targeted manner.

Particularly preferably, the freewheel further comprises a stop limiting the translational displacement of the freewheel element relative to the friction element. In particular, the stop is designed to limit a displacement of the freewheel element away from the first gear cog. Preferably, when the freewheel element thereby adjoins the stop and during further relative rotation of the output shaft and crankshaft, the force closure between the output shaft and the friction element is overcome, so that the output shaft can rotate relative to the friction element. The stop enables a particularly compact and precisely defined design of the freewheel.

Preferably, the stop is formed on the friction element. In particular, if the friction element is at least partially designed as a hollow shaft within which the freewheel element is arranged, a particularly simple and cost-efficient design with a few components can be achieved. For example, the stop can be formed by a securing ring arranged on the inner circumference of the friction element.

Preferably, the stop is designed such that the two gear cogs are completely disengaged from each other when the freewheel element adjoins the stop. In other words, the stop enables such a relative translational displacement of the freewheel element towards the friction element, so the two gear cogs no longer touch each other when the stop is reached. A particularly low-wear operation of the freewheel can thereby be ensured.

Further preferably, the helical mechanism is designed such that the tooth engagement of the two gear cogs is disengaged by the relative translational displacement during a relative rotation of the freewheel element and the friction element in the freewheel direction. In addition, the helical mechanism is designed such that the relative translational displacement of the freewheel element and the friction element in relation to each other during relative rotation in the locking direction engages the tooth engagement of the gear cogs. In other words, during rotation in the freewheel direction, a torque transfer between the crankshaft and output shaft is removed, and during rotation in the opposite locking direction, torque transfer is enabled.

Preferably, the friction element is attached to the output shaft in an axially non-rotatable manner. In particular, sub-regions of the output shaft and the friction element intersect in the axial direction. Preferably, the both sides of the friction element are in this case attached to the output shaft in an axially non-rotatable manner.

Preferably, the freewheel element is attached to the crankshaft in an axially displaceable manner and in a non-rotatable manner in the circumferential direction by means of a radial gear cog. For example, a splined connection between the freewheel element and the crankshaft can be designed as a radial gear cog. This ensures robust torque transfer between the freewheel element and the crankshaft in a simple manner when the function is ensured.

Preferably, the freewheel element is designed in two parts and comprises a gearwheel and a fixed ring. The gearwheel in this case comprises the second gear cog. The fixed ring comprises a part of the helical mechanism, which part is in particular engaged with the friction element. The gearwheel and the fixed ring are in this case connected to each other in a rotationally fixed manner. In particular, the gearwheel and the fixed ring are mechanically fixed to one another. A two-part design enables ease of assembly. In addition, various materials can, e.g., be used to adapt the respective areas of the freewheel element to the respective requirements in a particularly targeted manner.

Alternatively, the freewheel element can be designed as an integral component comprising the second gear cog and the part of the helical mechanism.

Preferably, the gear cogs are designed as sawtooth cogs or Hirth cogs. Sawtooth cogs are considered to be gear cogs having different inclined tooth flanks relative to an axial direction. In this case, one of the two tooth flanks of each tooth can, e.g., be arranged parallel to the axial direction. Hirth cogs are considered to be gear cogs having symmetric teeth.

Particularly preferably, the output shaft is designed as a hollow shaft. The crankshaft is thereby rotatably mounted within the output shaft. Preferably, at least one bearing between the crankshaft and the output shaft is provided for rotatable mounting. For example, the bearing can be designed as a needle bearing for a particularly compact design in the radial direction.

Furthermore, the disclosure results in a vehicle, in particular a two-wheeled cycle, preferably an electric bike, comprising the freewheel described.

Preferably, the vehicle further comprises a drive unit connected to the output shaft, in particular in a torque transmitting manner, and a crankshaft drive connected to the crankshaft, in particular in a torque transmitting manner

### BRIEF DESCRIPTION OF THE DRAWINGS

The disclosure is described in the following with reference to exemplary embodiments in conjunction with the drawings. In the drawings, functionally identical components are identified using the same respective reference characters. Shown are:

FIG. 1 a simplified schematic view of a vehicle with a freewheel according to a preferred exemplary embodiment of the disclosure,

FIG. 2 a detailed sectional view of a drive of the vehicle of FIG. 1,

FIG. 3 a perspective view of the motor shown in FIG. 2,

FIG. 4 a sectional view of the freewheel of FIG. 1 in the disengaged state, and

FIG. 5 a sectional view of the freewheel of FIG. 1 in the engaged state.

### DETAILED DESCRIPTION

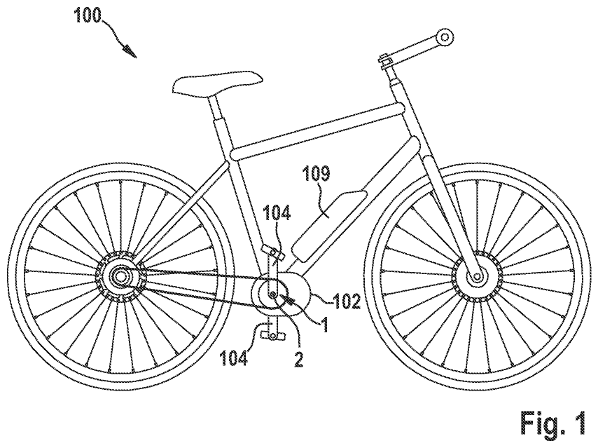

FIG. 1 shows a simplified schematic view of a vehicle 100 comprising a freewheel 1 according to a preferred exemplary embodiment of the disclosure. The vehicle 100 is a vehicle 100 that can be operated with muscle power and/or motor power, in detail an electric bike.

The vehicle 100 comprises a drive unit 102 that has a motor that is, in particular, an electric motor. The motor can be powered with electrical energy by means of an electrical energy store 109 of the vehicle 100.

The drive unit 102 is arranged in the area of a bottom bracket of the electric bike 100. A motor torque generated by the motor can be used to provide motorized support for the pedaling force generated by the muscle power of a rider of the electric bike 100.

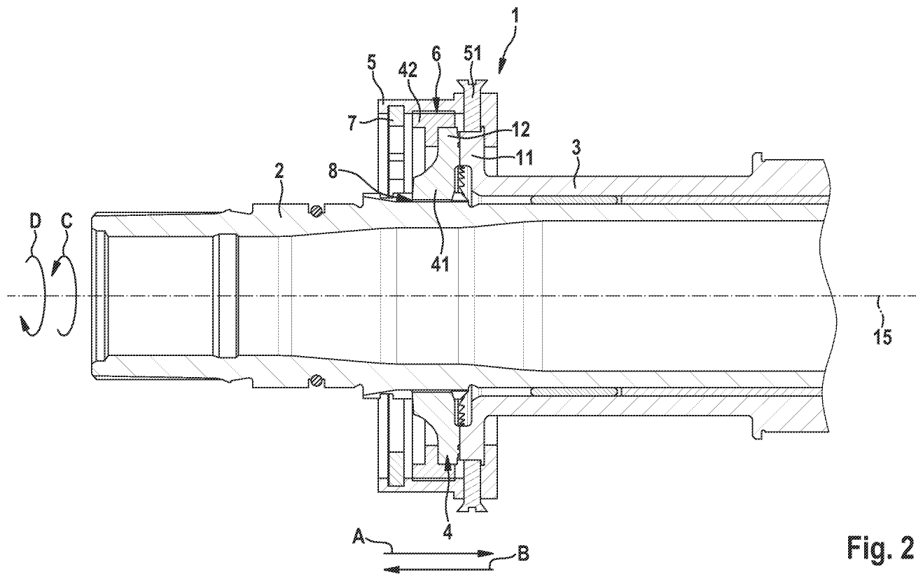

The muscle power of the driver can in this case be applied to a crankshaft 2 via a crank drive 104 which has cranks. The crankshaft 2 extends along a crank axis 15 and is arranged coaxially to an output shaft 3 of the drive unit 102 (see FIG. 2).

The drive unit 102 can in this case drive the output shaft 3 by means of the generated motor torque. The output shaft 3 is in this case designed as a hollow shaft, through which the crankshaft 2 protrudes completely. The crankshaft 2 is thereby rotatably arranged within the output shaft 3.

A freewheel 1 is provided between the crankshaft 2 and output shaft 3, which can produce or interrupt torque transfer between the crankshaft 2 and output shaft 3 depending on the relative rotation set-up of the crankshaft 2 and output shaft 3.

The exact operation and design of the freewheel 1 is described in detail hereinafter with respect to FIGS. 2 to 5.

The freewheel 1 comprises a freewheel element 4 and a friction element 5, which are arranged substantially coaxially to the crankshaft 2 and output shaft 3.

The freewheel element 4 is in this case designed to be disc-shaped and is arranged directly on an outer circumference of the crankshaft 2. By means of radial gear cogs 8 which can, e.g., be arranged in the form of a spline shaft connection, the freewheel element 4 is arranged on the crankshaft 2 to be displaceable in the axial direction und unable to rotate in the circumferential direction.

The freewheel element 4 comprises second front gear cogs 12 on a front axial face. First front gear cogs 11 are formed on the output shaft 3, in particular on a radially outwardly projecting flange of the output shaft 3. The first front gear cogs 11 and the second front gear cogs 12 are configured to effect torque transfer when engaged with each other.

In other words, when the freewheel element 4 is displaced to the right in the direction indicated by arrow A towards the first front gear cogs 11 until the two front gear cogs 11, 12 engage with each other, a torque transfer between the output shaft 3 and the freewheel element 4 is enabled. The radial gear cogs 8 between the freewheel element 4 and the crankshaft 2 thus also enables torque transfer between the crankshaft 2 and the output shaft 2 via the freewheel element 4. This state in which the two front gear cogs 11, 12 engage with each other is referred to as the engaged state of the gear cogs. The engaged state is shown in FIG. 5.

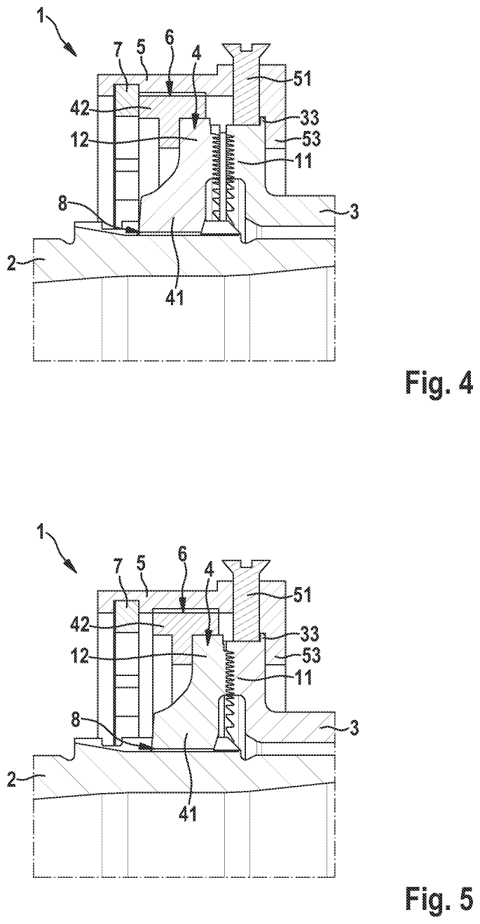

When the freewheel element 4 is displaced to the left away from the first front gear cog 11 in the direction (indicated by arrow B) until the two front gearings 11, 12 no longer engage with each other, the torque transfer between the output shaft 3 and the freewheel element 4, and thus also between the crankshaft 2 and the output shaft 3, is interrupted. This state in which the two front gear cogs 11, 12 do not engage with each other will also be referred to as the disengaged state of the gear cog. The disengaged state is shown in FIG. 4.

The engagement and disengagement of the gear cog is therefore caused by the translational displacement of the freewheel element 4 along the axial direction relative to the output shaft 3, and in particular also relative to the crankshaft 2.

This translational displacement of the freewheel element 4 is in this case effected as a function of a relative rotation of the crankshaft 2 and the output shaft 3 in a specific rotational apparatus and by the friction element 5, as described hereinafter.

The friction element 5 is designed as a hollow shaft or substantially sleeve-shaped and is arranged radially outside of the output shaft 3 and the freewheel element 4. The friction element 5 is in this case attached to the output shaft 3 in an axially non-rotatable manner, in which case relative rotation between the friction element 5 and the output shaft 3 is possible. However, a predetermined friction closure in the circumferential direction in the form of a friction closure formed between the friction element 5 and the output shaft 3, which closure causes the friction element 5 to rotate with the output shaft 3 if the friction closure is not overcome.

The friction element 5 comprises a plurality of screws 51, which are evenly distributed around the circumference of the output shaft 3, which protrude through the sleeve-shaped base body of the friction element 5 and push in a radial direction against the flange of the output shaft 3, on which the first front gear cog 11 is located. The radial force and thus the frictional force of the friction closure can be adjusted by setting the screw torque accordingly.

The axially non-displaceable attachment of the friction element 5 to the output shaft 3 is accomplished by the fact that a radially outwardly projecting shoulder 33 on the flange of the output shaft 3 intersects in the axial direction with the screws 51 and a radially inwardly projecting shoulder 53 of the friction element 5. The screws 51 can therefore also be used to enable particularly simple assembly of the freewheel 1.

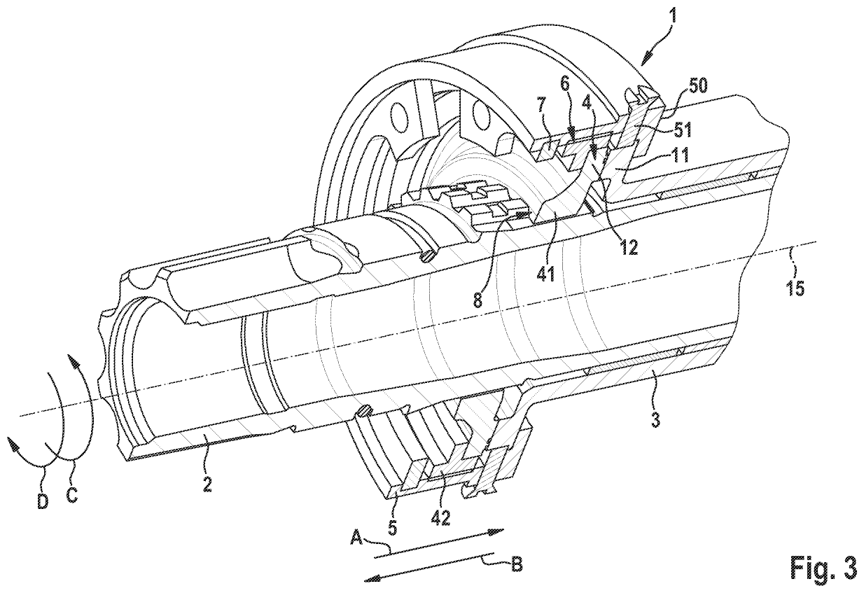

The freewheel 1 also comprises a helical mechanism 6, which is formed between the freewheel element 4 and the friction element 5. In the exemplary embodiment shown, the helical mechanism 6 in this case comprises a thread between a radially inner side of the friction element 5 and a radially outer side of the freewheel element 4. The thread of the helical mechanism 6 is in this case designed such that, during relative rotation of the crankshaft 2 in the locking direction C, it causes the gear cog to engage, i.e., the tooth engagement of the two front gear cogs 11, 12, by displacing the freewheel element 4 in the direction of arrow A (see FIGS. 2 and 3). In a similar manner, during relative rotation of the crankshaft 2 in the opposite freewheel direction D, the disengagement of the gear cog, i.e., the release of the tooth engagement of the two front gear cogs 11, 12 is effected by displacing the freewheel element 4 in the direction of arrow B.

The freewheel 1 in this case also comprises a stop 7, which limits the axial displacement of the freewheel element 4 relative to the friction element 5. For this purpose, the stop 7 comprises a securing ring that is arranged in a groove on a radially inner side of the sleeve-shaped friction element 5.

When the freewheel element 4 is displaced so far that the stop 7 is reached (as shown in FIG. 4), during further relative rotation of the crankshaft 2 in the freewheel direction D, the friction closure between the friction element 5 and the output shaft 3 is overcome, so that the friction element 5 and the output shaft 3 rotate relative to each other.

In the exemplary embodiment shown, the freewheel element 4 is designed in two parts and comprises a gear cog 41, on which the second front gear cog 12 is formed, and a fixed ring 42, which comprises a part of the thread of the helical mechanism 6. The gear cog 41 and the fixed ring 42 are in this case fixed to each other by means of a fixed connection in a non-rotatable and non-displaceable manner.

What is claimed is:

1. A freewheel of a vehicle, comprising:
a crankshaft;
an output shaft having a first gear cog;
a freewheel element having a second gear cog; and
a friction element,
wherein the first gear cog and the second gear cog are configured to, when engaged with each other, effect a torque transfer between the output shaft and the freewheel element,
wherein the freewheel element is arranged to be displaceable in the axial direction on the crankshaft,
wherein the freewheel element is arranged to be non-rotatable relative to the crankshaft in the circumferential direction, and
wherein the freewheel element and the friction element are connected to each other by way of a helical mechanism which is configured to effect a translational displacement of the freewheel element and the friction element relative to each other during relative rotation of the freewheel element and the friction element.

2. The freewheel according to claim 1, wherein the helical mechanism includes a thread.

3. The freewheel according to claim 1, wherein a predetermined friction closure in the circumferential direction is formed between the output shaft and the friction element.

4. The freewheel according to claim 3, wherein the frictional closure between the output shaft and the friction element includes a frictional force in the circumferential direction.

5. The freewheel according to claim 4, wherein the friction force is generated by way of at least one screw and/or by way of a friction ring.

6. The freewheel according to claim 5, wherein the force closure between the output shaft and the friction element includes a magnetic force.

7. The freewheel according to claim 1, further comprising a stop configured to limit the translational displacement of the freewheel element relative to the friction element.

8. The freewheel according to claim 7, wherein the stop is formed on the friction element.

9. The freewheel according to claim 7, wherein the stop is designed such that, when the freewheel element adjoins the stop, the gear cogs are completely disengaged from one another.

10. The freewheel according to claim 1, wherein the helical mechanism is designed such that the corresponding relative translational displacement during relative rotation in the freewheel direction disengages the tooth engagement of the gear cogs and, during relative rotation in the locking direction, engages the tooth engagement of the gear cogs.

11. The freewheel according to claim 1, wherein the friction element is attached to the output shaft in an axially non-displaceable manner.

12. The freewheel according to claim 1, wherein the freewheel element is attached to the crankshaft in an axially displaceable manner and in a non-rotatable manner in the circumferential direction by way of a radial gear cog.

13. The freewheel according to claim 1, wherein:
the freewheel element is designed in two parts, with a gear cog including the second gear cog and with a fixed ring including a part of the helical mechanism, and
the gear cog and the fixed ring are connected to each other in a rotationally fixed manner.

14. The freewheel according to claim 1, wherein:
the output shaft is designed as a hollow shaft, and
the crankshaft is rotatably mounted within the output shaft.

15. A vehicle comprising a freewheel according to claim 1.

16. The vehicle according to claim 15, further comprising:
a drive unit connected to the output shaft, and
a crank drive connected to the crankshaft.

17. The freewheel according to claim 1, wherein the vehicle is a two-wheeler.

18. The vehicle according to claim 15, wherein the vehicle is an electric bike.
